(19) United States
(12) Patent Application Publication
(10) Pub. No.: US 2007/0133983 A1
(43) Pub. Date: Jun. 14, 2007

(54) Light-controlling element for a camera

(76) Inventor: Matilda Traff, Lund (SE)

Correspondence Address: HARRITY SNYDER, L.L.P.;Suite 600, 11350 Random Hills Road, Fairfax, VA, 22030, US

(21) Appl. No.: 11/352,284

(22) Filed: Feb. 13, 2006

Related U.S. Application Data
(60) Provisional application No. 60/750,033, filed on Dec. 14, 2005.

(51) Int. Cl. G03B 9/02

(52) U.S. Cl. 396/506

(57) ABSTRACT

A light-controlling element for a camera, and a method and computer program product for admitting light to pass through such light-controlling element. The light-controlling element comprises a first zone and a second zone. The first zone is configured to admit light to pass through the light-controlling element. Furthermore, the second zone has a transmittance, which is controllable for adjusting the area of the first zone.

### RELATED APPLICATIONS

This application claims priority under 35 U.S.C. § 119 based on U.S. Provisional Application Ser. No. 60/750,033, filed Dec. 14, 2005, the disclosure of which is incorporated herein by reference.

### TECHNICAL FIELD OF THE INVENTION

The present invention relates to a light-controlling element for a camera. The light-controlling element comprises a first zone for admitting light to pass through the light-controlling element, and a second zone having a transmittance, which is controllable for adjusting the area of the first zone. The invention also relates to a method and a computer program product for admitting light to pass through such light-controlling element.

### DESCRIPTION OF RELATED ART

In a camera, the depth of field can in general be varied by varying the radius of an aperture stop and thereby regulating the diameter of the opening of the light path through the camera. For example, a smaller radius of the aperture stop gives a longer depth of field than a larger radius of the aperture stop. Also, the amount of light that enters into the camera may vary in dependence of the radius of the aperture stop. A larger depth of field in general means that the image can be sharp over a larger distance in front of and behind the focus plane of the camera. The depth of field may also depend on the distance from the object to the camera lens. A smaller distance generally means a smaller depth of field, whereas a larger distance generally means a larger depth of field.

A variable aperture stop may, e.g., be provided by a mechanical component, such as a mechanical variable iris, comprised in the camera. A variable aperture stop is used to mean an aperture stop having a radius, which is variable for regulating the diameter of the opening of the light path through the aperture stop. In general, the variable iris comprises several blades for thereby forming the aperture stop. The size of the radius of the aperture stop may be dependent on how much the blades of the mechanical variable iris are closed. A camera having a mechanical variable iris in general makes it possible for the user of the camera to experience creative photography. However, although the mechanical variable iris may provide for relatively good image quality, the mechanical variable iris is a relatively bulky mechanical component that may require considerable space. Furthermore, variable irises of the above type are most often not perfectly circular. This may potentially result in an unwanted diffraction phenomenon due to, e.g., sharp edges of the iris. In night images this may sometimes, e.g., be viewed as rays projecting out from a lamp against a dark background.

It is becoming more and more popular to provide a small-sized device such as a portable communication device, e.g., a mobile telephone, with a camera. The integration of the camera into the portable communication device generally makes the design of the portable communication device more complex. For example, the camera needs to be small in order to be arranged in the portable communication device. Therefore, due to the limited space of a portable communication device, a camera in a portable communication device cannot have a bulky mechanical component such as the mechanical variable iris for providing the variable aperture stop. The quality of images taken by a camera not having a mechanical variable iris may however be deteriorated, compared to the quality of images taken by a camera having a mechanical variable iris. This may be inconvenient for users of a camera not having a mechanical variable iris who still demand good image quality of images taken by the camera.

### SUMMARY OF THE INVENTION

According to an embodiment, a light-controlling element for a camera comprises a first zone for admitting light to pass through the light-controlling element and a second zone having a transmittance, which is controllable for adjusting the area of the first zone.

The transmittance of the second zone may be optically controllable. The second zone may comprise a photochromic material which is optically controllable. The transmittance of the second zone may, e.g., be continuously controllable along a radial extension of the light-controlling element. Furthermore, the photochromic material may comprise photochromic particles, wherein the amount of the photochromic particles increases along a radial extension of the light-controlling element.

Alternatively, the transmittance of the second zone may be electrically controllable. The second zone may comprise an electrochromic material, which is electrically controllable. The second zone may alternatively comprise a material having suspended particles, which are electrically controllable. The transmittance of the second zone may, e.g., be controllable in discrete steps along a radial extension of the light-controlling element. Moreover, the second zone may comprise at least two sub-zones, wherein each of the at least two sub-zones is independently controllable.

According to another embodiment, a camera comprises a light-controlling element having a first zone for admitting light to pass through the light-controlling element and a second zone having a transmittance, which is controllable for adjusting the area of the first zone.

According to a further embodiment, a portable communication device comprises a camera having a light-controlling element with a first zone for admitting light to pass through the light-controlling element and a second zone having a transmittance, which is controllable for adjusting the area of the first zone. The portable communication device may be a portable or handheld mobile radio communication device, a mobile radio terminal, a mobile telephone, a cellphone, a pager, a communicator, a smartphone, a computer such as a laptop computer or any other electronic device having a camera.

According to yet another embodiment, a method for admitting light to pass through a light-controlling element, wherein the light-controlling element has a first zone for admitting light to pass through the light-controlling element, comprises controlling the transmittance of a second zone of the light-controlling element for adjusting the area of the first zone. The step of controlling may comprise optically controlling the transmittance of the second zone. The step of optically controlling the transmittance of the second zone may comprise exposing the light-controlling element to UV light. The step of controlling may alternatively comprise electrically controlling the transmittance of the second zone. The step of electrically controlling the transmittance may comprise applying a voltage to the second zone of the light-controlling element.

According to still another embodiment, a computer program product for admitting light to pass through a light-controlling element, wherein the light-controlling element has a first zone for admitting light to pass through the light-controlling element, is provided. The computer program product comprises a computer readable medium having computer readable code embodied therein, wherein the computer readable code comprises computer readable code configured to control the transmittance of a second zone of the light-controlling element for adjusting the area of the first zone.

Further embodiments of the invention are defined in the dependent claims.

Some embodiments of the invention provide for good image quality of a camera, compared to a camera not having a mechanical component such as a mechanical variable iris.

It is an advantage with embodiments of the invention that a variable aperture stop can be provided without the need for a separate mechanical component such as, e.g., the mechanical variable iris. Thus, the required space of the variable aperture stop is reduced.

### BRIEF DESCRIPTION OF THE DRAWINGS

Further objects, features and advantages of embodiments of the invention will appear from the following detailed description, reference being made to the accompanying drawings, in which:

FIG. 1a is a front view of a portable communication device having a camera;

FIG. 1b is a rear view of the portable communication of FIG. 1a;

FIG. 2 is a top view of a light-controlling element according to an embodiment of the invention;

FIG. 3a is a top view of a light-controlling element according to another embodiment of the invention;

FIG. 3b is a top view of a light-controlling element according to another embodiment of the invention;

FIG. 4 is a schematic cross-sectional view of a camera lens of a camera; and

FIG. 5 is a flowchart illustrating an embodiment of a method for admitting light to pass through a light-controlling element.

### DETAILED DESCRIPTION OF EMBODIMENTS

Specific embodiments of the invention will now be described with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

Embodiments of the invention provide a light-controlling element 20, 30a, 30b for a camera, and a method and a computer program product for admitting light to pass through such light-controlling element 20, 30a, 30b. According to embodiments of the invention, the light-controlling element 20, 30a, 30b comprises a first zone for admitting light to pass through the light-controlling element 20, 30a, 30b. Furthermore, the light-controlling element 20, 30a, 30b comprises a second zone having a transmittance, which is controllable for adjusting the area of the first zone. The area of the second zone is controllable in dependence of its transmittance. Furthermore, the area of the first zone is adjustable in dependence of the area of the second zone. Thus, the size of the first zone is adjustable in dependence of the size of the second zone. By controlling the transmittance of the second zone, the area of the first zone can be adjusted to either increase or decrease. When the transmittance of the second zone increases, the area of the first zone increases. Similarly, when the transmittance of the second zone decreases, the area of the first zone decreases. Consequently, the light-controlling element 20, 30a, 30b, provides for a variable opening of the light path through the light-controlling element 20, 30a, 30b.

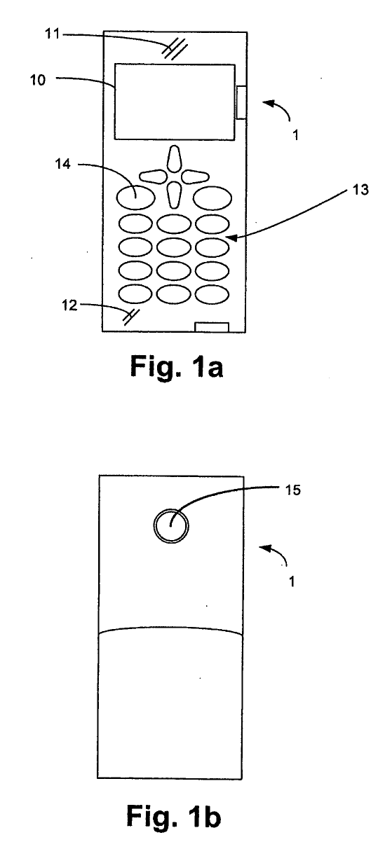

FIG. 1 illustrates a portable communication device 1 having a camera. In this illustration, the portable communication device 1 is embodied as a mobile telephone. The invention is not limited to a mobile telephone. In other embodiments, the portable communication device 1 may be a portable or handheld mobile radio communication device, a mobile radio terminal, a cellphone, a pager, a communicator, a smartphone or a computer such as a laptop computer or any other electronic device having a camera. In FIG. 1a, a front view of the portable communication device 1 is shown. The portable communication device 1 may, e.g., comprise a user interface including, but not limited to, a display 10, a loudspeaker 11, a microphone 12, and a keypad 13 with one or more keys for controlling one or several aspects of the portable communication device 1. One of the keys, e.g., key 14, may act as a shutter release button for taking an image with a camera (not shown), which is integrated in the portable communication device 1. FIG. 1b illustrates a rear view of the portable communication device 1 shown in FIG. 1a. The rear of the portable communication device 1 comprises a cover glass 15 of the camera (not shown). The position of the cover glass 15 of the camera shown in FIG. 1 is illustrative only. It could be positioned differently, such as, for instance, at the front of the portable communication device 1.

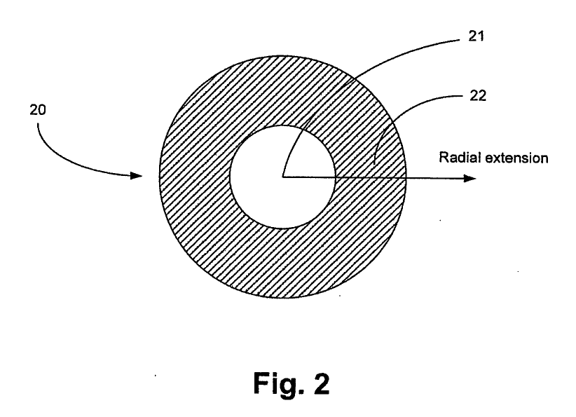

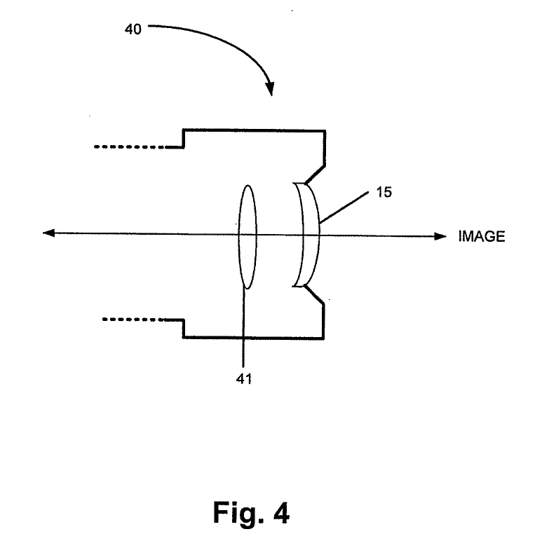

FIG. 2 illustrates a top view of a light-controlling element 20 for a camera according to an embodiment of the invention. The light-controlling element 20 may be circular. Furthermore, the light-controlling element 20 may be applied to a lens element 41 or the cover glass 15 of a camera lens 40 of the camera (FIG. 4). The light-controlling element 20 is capable of restricting an opening of the light path through the light-controlling element 20. Consequently, the light-controlling element 20 is adapted to regulate the amount of light that passes through the light-controlling element 20.

The light-controlling element 20 comprises a first zone 21 and a second zone 22. The total area of the light-controlling element 20 may be fixed. Furthermore, the first zone 21 and the second zone 22 may have a interrelationship, wherein the area of the first zone 21 increases when the area of the second zone 22 decreases, and vice versa. Thus, the area of the first zone 21 is adjustable in dependence of the area of the second zone 22. The first zone 21 is configured to admit light to pass through the light-controlling element 20. That is, the transmittance of the first zone 21 is such that light may pass therethrough. The first zone 21 may, e.g., be transparent. Furthermore, the second zone 22 has a controllable transmittance. The area of the second zone 22 may be controllable in dependence of its transmittance. Thus, by controlling the transmittance of the second zone 22, the area of the first zone 21 may be adjusted to either increase or decrease. When the transmittance of the second zone 22 increases, the area of the first zone 21 increases. Also, when the transmittance of the second zone 22 decreases, the area of the first zone 21 decreases. Consequently, the size of the opening of the light path through the light-controlling element 20 is variable.

In this embodiment, the transmittance of the second zone 22 is optically controllable. The second zone 22 may, e.g., comprise a photochromic material, which is optically controllable. For example, a film of the photochromic material may be applied onto the lens element 41 or the cover glass 15 of the camera lens 40 (FIG. 4). As one illustrative example, the photochromic material may comprise molecules of substances such as silver chloride or silver halide. These molecules are in general transparent to visible light in the absence of ultraviolet (UV) light, which is normal, e.g., for artificial lighting. However, when exposed to UV light, e.g., in sunlight, these molecules in general undergo a chemical process that causes them to change shape. The new molecular structure absorbs portions of the visible light, thereby causing the photochromic material to darken. The number of molecules that change shape in general varies with the intensity of the UV light. On the other hand, the absence of the UV light in general causes the molecules to return to their original shape, thereby resulting in a loss of their light absorbing properties.

Photochromic materials are configured to change from a first state to a second state depending on the amount of UV light they are exposed to. The transmittance of the photochromic material may hence be configured to change in dependence of the exposure to UV light. Photochromic materials may, for example, be adapted to change from transparent to opaque. For instance, the photochromic material may have a relatively low transmittance, e.g., being substantially opaque, when exposed to UV light, which is e.g. the case in sunlight. On the other hand, the photochromic material may have a relatively high transmittance, e.g., being substantially transparent, when exposed to little or no UV light, such as, e.g., indoors. It is hence possible to provide a light-controlling element 20, wherein the size of the opening of the light path through the light-controlling element 20 is determined in dependence of the exposure to UV light. A dual aperture stop can be obtained.

In low-light conditions, the illuminance may, e.g., be in the range of 300-500 lux. This is, for example, the case indoors where little or no UV light is present. In low-light conditions, the second zone 22 is adapted to admit light to pass therethrough. Thus, the area of the first zone 21 will be adjusted to increase, thereby leaving a relatively large opening in the light path through the light-controlling element 20. A maximum amount of light may consequently enter into the light-controlling element 20 and hence the camera when the first zone 21 has a maximum area. Hence, a maximum aperture stop may be utilized in low-light conditions. However, in a brighter light condition, the illuminance may, e.g., be in the magnitude of 10 000 lux. This is, for example, the case in sunlight where UV light is present. In a bright-light condition, a minimum amount of light may enter into the light-controlling element 20 because the transmittance of the second zone 22 will decrease, thereby leaving a relatively smaller area of the first zone 21 and thus also a smaller opening in the light path through the light-controlling element 20. Accordingly, a smaller aperture stop may be utilized in bright-light conditions, when the first zone 21 has a minimum area.

When the light-controlling element 20 is implemented in the camera, e.g., by being applied onto the lens element 41 or the cover glass 15 (FIG. 4), it may provide for a camera, in which the depth of field may vary in dependence of the exposure to light. The depth of field may increase in bright-light environments, e.g., in sunlight. Furthermore, less light may enter into the camera in bright-light environments. The required depth of field in bright-light conditions may determine the area of the first zone 21 of the light-controlling element 20, and hence the opening in the light path through the light-controlling element 20. It is possible to get a large depth of field in bright-light conditions, and still have a relatively good performance in low-light conditions. This can be accomplished without an extra element such as a mechanical variable iris. Thus, the required space of the camera may be reduced, compared to a camera having a separate mechanical variable iris. This provides for small cameras with relatively good performance. This may be advantageous if the camera is to be integrated in a small-sized device such as the portable communication device 1.

In further embodiments, the transmittance of the second zone 22 is continuously controllable along a radial extension from the center of the light-controlling element 20 to the periphery of the light-controlling element 20. For example, an amount of photochromic particles included in the photochromic material of the second zone 22 may increase along the radial extension. This may provide for a gradual transmittance of the second zone 22 in dependence of the exposure to light. Accordingly, the aperture stop can be gradually varied in dependence of the exposure of the light-controlling element 20 to light. For example, the amount of photochromic particles included in the photochromic material of the second zone 22 may increase linearly, exponentially or logarithmically along the radial extension.

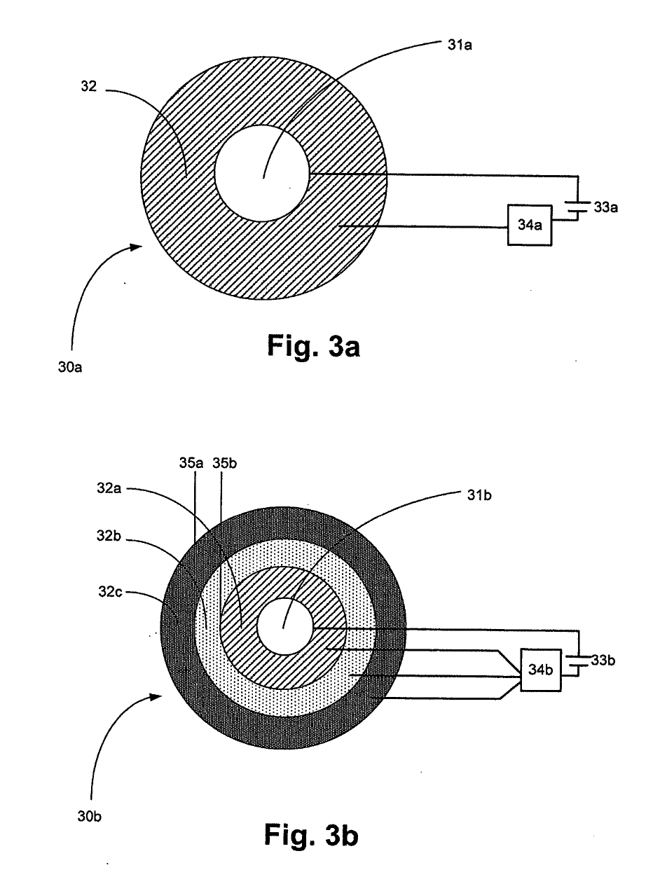

FIG. 3a illustrates a light-controlling element 30a for a camera according to another embodiment of the invention. The light-controlling element 30a may be circular. Furthermore, the light-controlling element 30a may be applied to the lens element 41 or the cover glass 15 of the camera lens 40 (FIG. 4). The light-controlling element 30a is capable of restricting an opening of the light path through the light-controlling element 30a. Consequently, the light-controlling element 30a is adapted to regulate the amount of light that passes through the light-controlling element 30a.

The light-controlling element 30a comprises a first zone 31a and a second zone 32. The total area of the light-controlling element 30a may be fixed. Furthermore, the first zone 31a and the second zone 32 may have a interrelationship, wherein the area of the first zone 31a increases when the area of the second zone 32 decreases, and vice versa. Thus, the area of the first zone 31a is adjustable in dependence of the area of the second zone 32. The first zone 31a is configured to admit light to pass through the light-controlling element 30a. That is, the transmittance of the first zone 31a is such that light may pass therethrough. The first zone 31a may, e.g., be transparent. Furthermore, the second zone 32 has a controllable transmittance. The area of the second zone 32 may be controllable in dependence of its transmittance. Thus, by controlling the transmittance of the second zone 32, the area of the first zone 31a may be adjusted to either increase or decrease. When the transmittance of the second zone 32 increases, the area of the first zone 31a increases. Moreover, when the transmittance of the second zone 32 decreases, the area of the first zone 31 decreases. The size of the opening of the light path through the light-controlling elements 30a is thus variable.

In this embodiment, the transmittance of the second zone 32 is electrically controllable. For example, a voltage source 33a may be provided for applying a voltage to the second zone 32. Furthermore, a selector 34a may be adapted to select a level of the voltage that is to be applied to the second zone 32.

The second zone 32 may, e.g., comprise an electrochromic material. An electrochromic material is a material in which a chemical reaction begins when a voltage is applied to it. For example, the electrochromic material may comprise two electrochromic layers, wherein ions (and electron Yeah, buts for neutrality in charge) may be transported between said two electrochromic layers. A first electrochromic layer of the two electrochromic layers may be adapted to darken when ions leave said first layer. A second electrochromic layer of the two electrochromic layers may be adapted to darken when ions enter said second layer. Between the two electrochromic layers, there may be provided a polymeric ionic conductor. A voltage may, e.g., be applied to the elechtrochromic material via transparent electrodes. For example, a Ni-based oxide and an amorphous wolfram oxide may be used for the two electrochromic layers.

The reflection and absorption properties of the electrochromic material may change in dependence of the applied voltage. Accordingly, the transmittance of the second zone 32 may be varied in dependence of the applied voltage and is thus electrically controllable. For example, the electrochromic material may be configured to change its chemical state from opaque to transparent. The properties of electrochromic materials and methods for applying a voltage to the same are known in the art and will not be further explained herein.

The second zone 32 is considered to comprise an electrochromic material, which has the ability to change its transmittance with the use of an applied voltage. The second zone 32 may, e.g., be configured to be set in a first state or a second state. In the first state, when voltage is applied to the second zone 32, the transmittance of the second zone 32 is such that substantially no light may pass through the second zone 32, i.e., light is blocked. In the second state, when no voltage is applied to the second zone 32, the transmittance of the second zone 32 is such that light may pass through the second zone 32. Accordingly, when a voltage is applied to the second zone 32, the second zone 32 may change its transmittance.

In some embodiments, it is possible to control the level of the applied voltage by means of the selector 34a. Thereby, it is possible to gradually control the transmittance of the second zone 32 such that the transmittance of the second zone 32 can be varied from a relatively low transmittance (e.g., the second zone 32 is substantially opaque) to a relatively high transmittance (e.g., the second zone 32 is substantially transparent).

By controlling the transmittance of the second zone 32, the area of the first zone 31a may be adjusted to either increase or decrease. When the transmittance of the second zone 32 increases, the area of the first zone 31a increases, and vice versa. It is hence possible to select how much light should enter through the light-controlling element 30a. Different sizes of the opening in the light path of the first zone 31a of the light-controlling element 40 can be selected by applying a voltage to the second zone 32 and thereby controlling the transmittance of the second zone 32. This may provide for a light-controlling element 30a with variable aperture stops. Different sizes of the aperture stop can be obtained by electrically controlling the transmittance of the second zone 32. It is hence possible to allow for a camera with a selectable aperture stop. A camera having limited size but with a variable aperture that is controllable by the user can thus be obtained.

Alternatively, the second zone 32 may comprise a material having suspended particles, which are electrically controllable. The material may, e.g., be an SPD (Suspended Particle Device) material having light-absorbing particles. The SPD may, e.g., be placed between two panels of glass or plastic, which are coated with a transparent conductive material. When a voltage is applied to the coating, the light-absorbing particles may line up thereby allowing light to pass through. Thus, when a voltage is applied to a second zone 32 comprising a SPD material, the transmittance of the second zone 32 is such that light may pass therethrough. On the other hand, when the voltage is removed, the light-absorbing particles may return to a random pattern thereby blocking the light. Accordingly, when no voltage is applied to the second zone 32 comprising a SPD material, the transmittance of the second zone 32 is such that substantially no light may pass through the second zone 32. The properties of SPD materials and methods for applying a voltage to the same are known in the art and will not be further explained herein.

FIG. 3b illustrates a light-controlling element 30b for a camera according to another embodiment of the invention. The light-controlling element 30b is similar to the light-controlling element 30a of FIG. 3a. However, the light-controlling element 30b differs from the light-controlling element 30a of FIG. 3a in that the second zone comprises a plurality of sub-zones 32a, 32b, and 32c. Each of the plurality of sub-zones 32a, 32b, 32c, may be independently controllable. Furthermore, each of the sub-zones 32a, 32b, 32c may be separated by a thin strip of isolating material 35a, 35b. In this embodiment, the selector 34b is configured to select none or some of the sub-zones 32a, 32b, 32c to which the voltage from the voltage source 33b should be applied. By selecting to which (or none) sub-zone of the independent sub-zones 32a, 32b, 32c to apply a voltage, it is possible to control the transmittance of none or several sub-zones 32a, 32b, 32c of the second zone. Thus, the transmittance of the second zone may be controllable in discrete steps along the radial extension from the center of the light-controlling element 30b to the periphery of the light-controlling element 30b.

By controlling the transmittance of none or some of the independently controllable sub-zones 32a, 32b, 32c, the area of the first zone 31 may be adjusted to either increase or decrease. When the transmittance of the second zone 32a, 32b, 32c increases, the area of the first zone 31b increases, and vice versa. Consequently, it is possible to select how much light should enter the light-controlling element 30b. Different sizes of the opening in the light path of the first zone 31b of the light-controlling element 40 can hence be selected. Different sizes of the aperture stop can be obtained, by applying voltage to none or some of the sub-zones 32a, 32b, and 32c. This may allow for an variable opening of the light path through the light-controlling elements 30b, wherein the opening is variable in a plurality of different discrete levels.

In some embodiments, it is possible to control the level of the applied voltage to each of the sub-zones 32a, 32b, 32c, and thereby gradually control the transmittance of each of the sub-zones 32a, 32b, 32c. Thereby, it is possible to gradually control the transmittance of each of the sub-zones 32a, 32b, 32c such that the transmittance of each of the sub-zones 32a, 32b, 32c can be varied from a relatively low transmittance (e.g. substantially opaque) to a relatively high transmittance (e.g. substantially transparent).

FIG. 4 illustrates some components that may be integrated in the camera lens 40 of the camera. The camera lens 40 may comprise a lens element 41. Only a single lens element 41 is shown in FIG. 4. However, in other embodiments, the camera lens 40 may comprise a plurality of lens elements 41. The camera lens 40 may also comprise the cover glass 15 shown in FIG. 1. As described earlier, the light-controlling element 20, 30a, 30b according to embodiments of the invention may be applied to the lens element 41 or the cover glass 15. This may provide for a camera with a variable aperture stop. It should be appreciated that, if the camera lens 40 comprises a plurality of lens elements 41, the light-controlling element could be applied onto any of said plurality of lens elements 41.

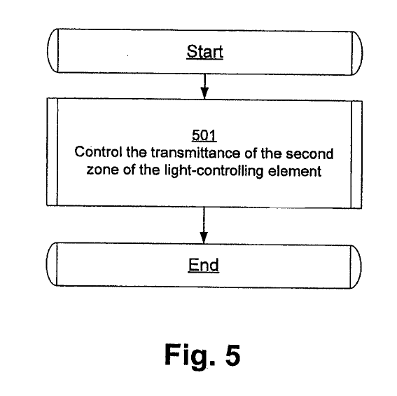

FIG. 5 illustrates a method for admitting light to pass through the light-controlling element 20, 30a, 30b according to embodiments of the invention. The light-controlling element 20, 30a, 30b comprises a first zone 21, 31a, 31b for admitting light to pass through the light-controlling element 20, 30a, 30b. The light-controlling element 20, 30a, 30b also comprises a second zone 22, 32, 32a, 32b, 32c having a transmittance, which is controllable for adjusting the area of the first zone 21, 31a, 31b.

In step 501, the transmittance of the second zone of the light-controlling element 20, 30a, 30b is controlled for adjusting the area of the first zone. By controlling, in step 501, the transmittance of the second zone, the area of the first zone may be adjusted to either increase or decrease. When the transmittance of the second zone is controlled to increase, the area of the first zone will increase. Similarly, when the transmittance of the second zone is controlled to decrease, the area of the first zone will decrease. Consequently, the size of an opening of the light path through the light-controlling element 20, 30a, 30b can be controlled in step 501. In some embodiments, step 501 comprises optically controlling the transmittance of the second zone. This can be achieved by exposing the light-controlling element 20 to UV light. In other embodiments, step 501 comprises electrically controlling the transmittance of the second zone. For example, the transmittance of the second zone may be controlled by applying a voltage to the second zone. The step of electrically controlling the transmittance of the second zone may further comprise electrically controlling none or some of a plurality of independently controllable sub-zones of the second zone.

The light-controlling element 20, 30a, 30b according to embodiments of the invention provide for a variable aperture stop, which is suitable for a camera. The variable aperture stop may be provided without the need of utilizing a comparatively more bulky component such as a mechanical variable iris. Thus, the required space of the aperture stop is reduced. As a consequence, embodiments of the invention allow for smaller cameras, compared to cameras having a mechanical variable iris. This may, for example, be advantageous in a camera, which is to be integrated into a small-sized device such as a portable communication device. Furthermore, embodiments of the present invention allow for good image quality, compared to a camera not having a component such as a mechanical variable iris. Moreover, some embodiments of the invention may, unlike mechanical variable irises, provide circular aperture stops, e.g., at least when the first zone 21, 31a, 31b is circular. Thus, unwanted diffraction phenomenon can be avoided. Accordingly, compared to a camera having a mechanical variable iris, some embodiments of the present invention allow for even better image quality.

As have been used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention have been described with reference to a portable communication device 1. However, the invention is not limited to cameras of portable communication devices. Rather, embodiments of the invention may be used in any portable electronic device that includes a camera.

The present invention may be embodied as a light-controlling element for a camera, a method or a computer program product. Accordingly, the present invention may take the form of an entirely hardware embodiment, a software embodiment or an embodiment combining software and hardware aspects all generally referred to herein as a unit or device. Furthermore, the present invention may take the form of a computer program product. The computer program product may be stored on a computer-usable storage medium having computer-usable program code embodied in the medium. Any suitable computer readable medium may be utilized including e.g. hard disks, CD-ROMs, a RAM (Random Access Memory), a ROM (Read Only Memory), a flash memory, optical storage devices, a transmission media such as those supporting the Internet or an intranet, or magnetic storage devices.

Embodiments of the present invention has been described herein with reference to a flowchart and/or a block diagram. It will be understood that some or all of the illustrated blocks may be implemented by computer program instructions. These computer program instructions may be provided to a processor of a general purpose computer, special purpose computer, or other programmable data processing apparatus to produce a machine, such that the instructions when executed create means for implementing the functions/acts specified in the flowchart otherwise described.

A computer program product may comprise computer program code portions for executing the method, as described in the description and the claims, for providing control data when the computer program code portions are run by an electronic device having computer capabilities.

A computer readable medium having stored thereon a computer program product may comprise computer program code portions for executing the method, as described in the description and the claims, for providing control data when the computer program code portions are run by an electronic device having computer capabilities.

A computer program product may comprise computer program code portions for executing the method, as described in the description and the claims, for requesting control data when the computer program code portions are run by an electronic device having computer capabilities.

A computer readable medium having stored thereon a computer program product may comprise computer program code portions for executing the method, as described in the description and the claims, for requesting control data when the computer program code portions are run by an electronic device having computer capabilities.

The present invention has been described above with reference to specific embodiments. However, other embodiments than the above described are equally possible within the scope of the invention. The different features and steps of the invention may be combined in other combinations than those described. The scope of the invention is only limited by the appended patent claims.

What is claimed is:

1. A light-controlling element for a camera, comprising:
a first zone for admitting light to pass through the light-controlling element, and
a second zone having a transmittance, which is controllable for adjusting the area of the first zone.

2. The light-controlling element of claim 1, wherein the transmittance of the second zone is optically or electrically controllable.

3. The light-controlling element of claim 2, wherein the second zone comprises a photochromic material, which is optically controllable.

4. The light-controlling element of claim 3, wherein the transmittance of the second zone is continuously controllable along a radial extension of the light-controlling element.

5. The light-controlling element of claim 3, wherein the photochromic material comprises photochromic particles, the amount of which increases along a radial extension of the light-controlling element.

6. The light-controlling element of claim 2, wherein the second zone comprises an electrochromic material, which is electrically controllable, or a material having suspended particles, which are electrically controllable.

7. The light-controlling element of claim 6, wherein the transmittance of the second zone is controllable in discrete steps along a radial extension of the light-controlling element.

8. The light-controlling element of claim 7, wherein the second zone comprises at least two sub-zones, wherein each of the at least two sub-zones is independently controllable.

9. A camera comprising the light-controlling element of claim 1.

10. A portable communication device comprising the camera of claim 9.

11. A method for admitting light to pass through a light-controlling element, the light-controlling element having a first zone for admitting light to pass through the light-controlling element, comprising:
controlling the transmittance of a second zone of the light-controlling element for adjusting the area of the first zone.

12. A computer program product for admitting light to pass through a light-controlling element, the light-controlling element having a first zone for admitting light to pass through the light-controlling element, the computer program product comprising:
a computer readable medium having computer readable code embodied therein, the computer readable code comprising:
computer readable code configured to control the transmittance of a second zone of the light-controlling element for adjusting the area of the first zone.
